(19) United States
(12) Patent Application Publication
(10) Pub. No.: US 2011/0319270 A1
(43) Pub. Date: Dec. 29, 2011

(54) Apparatus for Melting Metal Pieces

(75) Inventors: Jens Mueller, Bonn (DE); Jens Krause, Bonn (DE)

(73) Assignee: ZENERGY POWER GMBH, Rheinbach (DE)

(21) Appl. No.: 13/163,856

(22) Filed: Jun. 20, 2011

(30) Foreign Application Priority Data
Jun. 24, 2010 (DE) 102010024883.5

(51) Int. Cl. H01F 6/06; H01F 6/04; C22B 4/08; C22B 4/00

(52) U.S. Cl. 505/163; 266/242; 75/10.14

(57) ABSTRACT

An apparatus for melting down metal pieces and/or metal powders in a heat-resistant crucible which is enclosed by at least one coil arrangement generating a DC magnetic field predominantly penetrating the crucible transversely to its central axis and inducing short-circuit currents during rotation of the crucible around its central axis. The coil arrangement comprises at least one superconducting winding in a cryostat and a lowerable stamp rotates in the same direction as the crucible.

### CROSS REFERENCE TO RELATED APPLICATIONS

This application claims foreign priority under 35 U.S.C. §119(a)-(d) to Application No. DE 102010024883.5 filed on 24 Jun. 2010, entitled “An Apparatus for Melting Metal Pieces,” the entire contents of which are hereby incorporated by reference.

### FIELD OF THE INVENTION

The invention relates to an apparatus for melting down metals in form of pieces and/or powders in a heat-resistant crucible which is enclosed by at least one coil arrangement generating a DC magnetic field which predominantly penetrates the crucible transversely to its central axis and which generates short-circuit currents at least in the metal pieces and/or the metal powders during rotation of the crucible around its central axis.

### BACKGROUND

Apparatuses for melting metal are generally known. In the case of rotatably driven crucibles and stationary coil arrangements or in the case of the rotation of the coil arrangement and a stationary crucible (and also by rotating the crucible and the coil arrangement in opposite directions relative to one another), short-circuit currents are obtained (generated) in the metal pieces, which heat up the metal pieces. Heating up to and over the melting point will only be achieved in metals with a relatively low melting point (e.g., aluminum and certain aluminum alloys) due to the high melting heat only if appropriately high induction currents are generated in the metals. This cannot be achieved by a high rotational speed because the penetration depth of the magnetic field will decrease with rising rotational speed and, irrespective of this, the induced voltage and the short-circuit current caused by this voltage will be the lower the closer the respective metal piece is disposed to the central axis of the crucible. Consequently, a very strong magnetic field is required instead. That is why the coil arrangement must have a very high number of ampere turns, i.e. a winding with numerous windings with a large conductor cross-section and a respectively powerful direct current source. A considerable heat loss is therefore produced in the winding which needs to be dissipated by forced cooling, usually by using water-carrying copper pipes for the coil winding.

### SUMMARY

The invention is based on the object of providing an apparatus which allows melting down metal pieces and/or metal powders in a considerably more energy-saving manner in comparison with the above systems. In particular, the present invention is directed toward an apparatus for melting down metal pieces and/or metal powders, the apparatus including a heat-resistant crucible enclosed by at least one coil arrangement generating a DC magnetic field predominantly penetrating the crucible transversely to its central axis and inducing short-circuit currents during rotation of the crucible about its central axis, wherein the coil arrangement includes at least one superconducting winding in a cryostat; and a stamp arranged above the crucible, wherein the stamp is lowered onto metal pieces contained in the crucible, and wherein the stamp is rotatably driven in the same direction as the crucible.

### BRIEF DESCRIPTION OF THE DRAWINGS

FIG. 1 illustrates a partial sectional side view of an apparatus according to a first embodiment of the present invention.

FIG. 2 illustrates a perspective view of the apparatus shown in FIG. 1.

FIG. 3 illustrates a top view of the apparatus shown in FIG. 1.

FIG. 4 illustrates a perspective view of an apparatus in accordance with a second embodiment of the present invention.

FIG. 5 illustrates a perspective view of an apparatus in accordance with a third embodiment of the present invention.

FIG. 6 illustrates a top view of the third embodiment.

FIG. 7 illustrates a top view of an apparatus according to a fourth embodiment of the present invention.

FIG. 8 illustrates a top view of an apparatus in accordance with fifth embodiment of the present invention.

Like reference numerals have been used to identify like elements throughout this disclosure.

### DETAILED DESCRIPTION

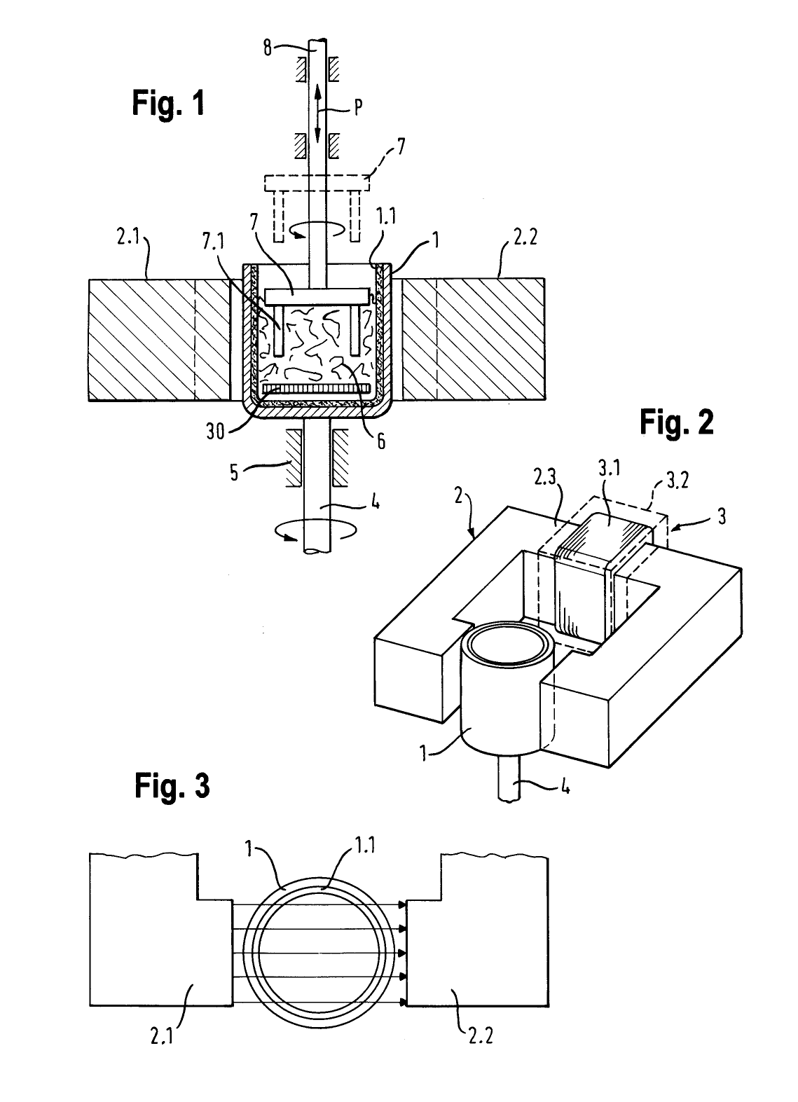

FIGS. 1 to 3 illustrate a first embodiment of the apparatus. It includes a crucible 1 with a refractory lining 1.1 between the pole pieces 2.1 and 2.2 of a C-shaped yoke 2. A coil arrangement 3 is disposed on the middle or median limb 2.3, which coil arrangement comprises a superconducting winding 3.1 in a generally known cryostat 3.2 (indicated with a broken line).

The superconducting winding 3.1 of the coil arrangement 3 carries a direct current and generates a magnetic flux in the C-shaped yoke 2, which magnetic flux penetrates the crucible 1, which is indicated by arrows in FIG. 3 (leakage flux has been omitted). The yoke 2 is arranged horizontally in this example.

The floor of the crucible 1 may be coupled in a torsion-proof but separable manner with a shaft 4 guided in at least one upper bearing 5 and is driven in operation of the apparatus on its part by a powerful electric motor (not shown). Conventional driving and coupling apparatuses may be utilized.

In accordance with FIG. 1, scrap metal 6 is disposed in the crucible 1 above a sacrificial plate 30 formed from the same material forming the scrap metal 6. A stamp 7 with several driving fingers 7.1 on the bottom side is immersible into the crucible 1. The stamp 7 and its driving fingers 7.1 may be formed of a refractory material or one with a high melting point. The stamp 7 can be made to rotate by means of a shaft 8 in the same direction as the shaft 4 and preferably also with the same rotational speed as the latter. In its lowered position (shown with the solid lines), the stamp 7 may be utilized to compress the scrap metal 6 in order to produce the longest possible current paths. The driving fingers 7.1 prevent the scrap metal 6 from falling behind the rotation of the crucible 1 and also later, after its melting, that the metal melt also falls behind the rotation of the crucible 1.

As shown, the stamp 7 is arranged above the crucible 1, which can be lowered onto the metal pieces 6 in the crucible. This improves the electrical contact between the metal pieces and thus accelerates the melting process. The stamp 7 rotates in the same direction and preferably synchronously with the crucible, so that the angular speed with which the metal pieces move will not drop behind that of the crucible and the amount of the short-circuit currents generated in the metal pieces by induction will not decrease thereby.

As a result of the low coefficient of friction between the melt and the inside wall of the crucible and additionally as a result of the braking effect which is generated by the interaction of the magnetic fields of the short-circuit currents with the magnetic field of the coil arrangement, the melt has the tendency to fall behind the rotation of the crucible. A further important improvement of the apparatus is therefore achieved if the stamp is provided with driving fingers 7.1 on the bottom side. Particularly when the metal pieces have been molten down completely or at least partly, the driving fingers prevent the melt from falling behind or the liquid metal layer that is formed first on the inside wall of the crucible.

The shaft 8 can be lifted (indicated by arrows P) from the lowered position to a raised position (indicated via broken lines), in which the crucible 1 can be filled with the scrap metal 6 on the one hand and in which the crucible 1 with the metal melt can be lifted out upward between the pole pieces 2.1 and 2.2 on the other hand and can be displaced by means of known horizontal conveyors and tilting apparatuses to a location and can be poured out at such location where the metal melt is required.

The stamp 7 and its drive as well as the content of the crucible 1 are removed in FIGS. 2 and 3 and the further drawings for reasons of clarity of the illustration.

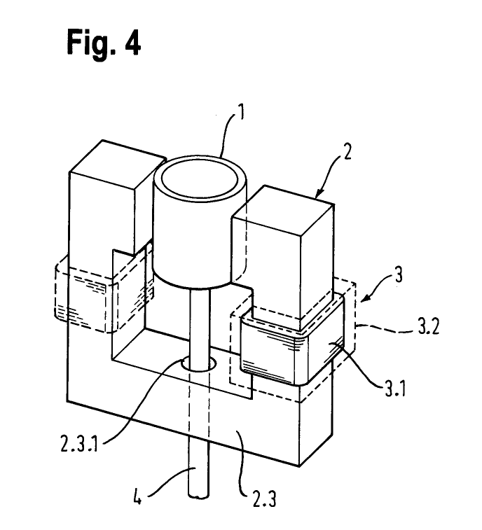

FIG. 4 shows a second embodiment of the apparatus (without stamp 7 and its drive). As shown, the C-shaped yoke 2 is arranged upright (i.e., in a vertical plane) in this embodiment, in contrast to FIG. 2. That is why the middle limb 2.3 has an opening or aperture 2.3.1 for the shaft 4 of the crucible 1. The coil arrangement 3 sits on the one of the two free (lateral) limbs of the C-shaped yoke 2. A division into two symmetric coil arrangements (the second coil arrangement is indicated via a broken line) is possible, but such an arrangement may increase costs.

An arrangement of the C-shaped yoke 2 as in FIG. 4 is especially useful if the apparatus is supplemented with a second C-shaped yoke 9 that carries an AC-supplied coil arrangement 10. This third embodiment is shown in FIG. 5 (shown without the stamp 7, etc. for reasons of clarity of the illustration). The C-shaped yokes 2 and 9 can also be arranged with exchanged positions, i.e., the yoke 2 disposed in a horizontal plane as in FIG. 2 and the yoke 9 in an upright position in a vertical plane, like the yoke 2 in FIG. 4.

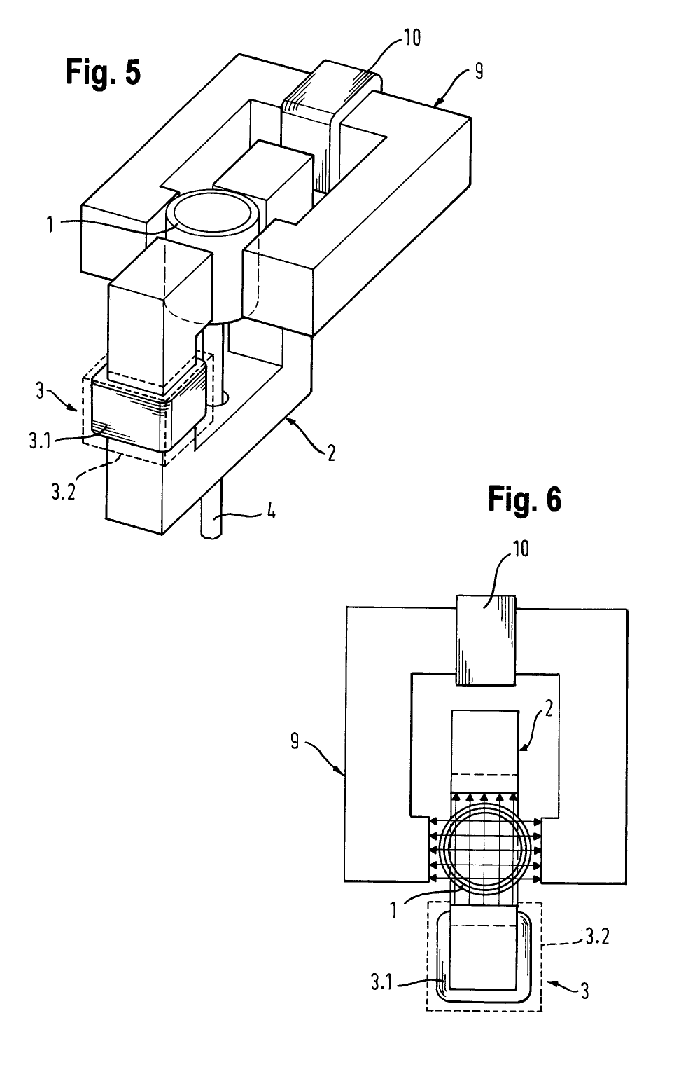

As is schematically indicated in the top view according to FIG. 6, the direct magnetic flux (indicated by single-headed directional arrows), which is generated in this embodiment by the superconducting winding 3.1 (FIG. 5), and the alternating magnetic flux (indicated by double arrows), which is generated by the normally conducting, AC-operated coil arrangement 10, penetrate the crucible 1 in a substantially orthogonal manner, as a result of which especially the initial phase of the heating of the crucible content will accelerate and can be reduced in respect of time.

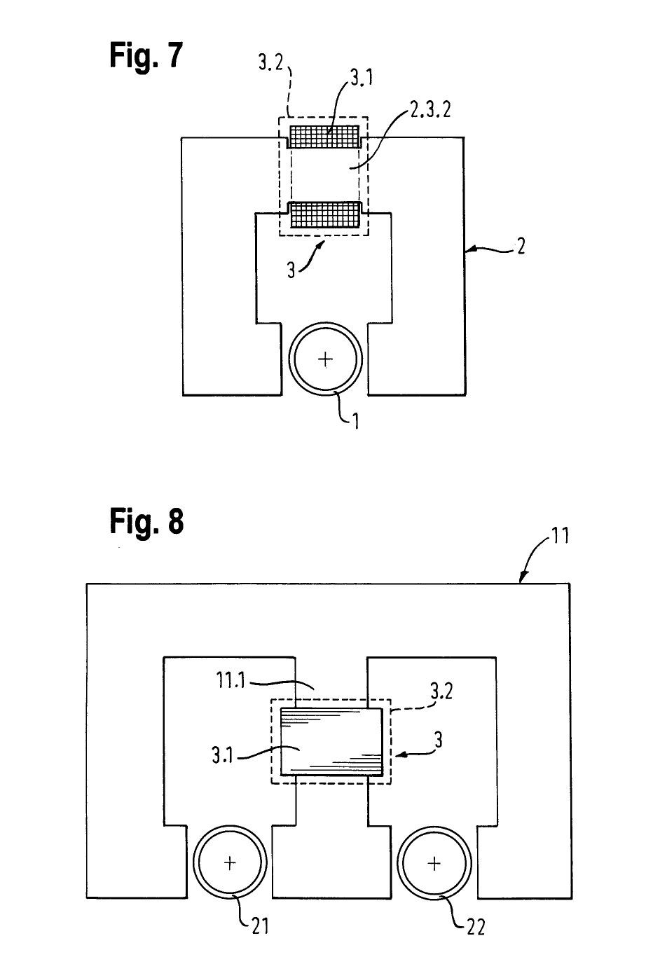

FIG. 7 schematically shows a top view of a fourth embodiment which corresponds substantially to the first embodiment, but with the difference that in the region of the winding 3.1 the cross-section of the yoke 2 is reduced in comparison with the cross-section of the other parts of the yoke. With this configuration, the back or reverse induction voltage (caused in the winding 3.1 by the temporary changing magnetic fields of the short-circuit currents) generated in the crucible and/or the crucible content can be reduced.

FIG. 8 schematically shows a fifth embodiment of the apparatus which allows heating the content of two crucibles 21 and 22 simultaneously as long as both crucibles are also rotatably driven simultaneously. This embodiment comprises an E-shaped yoke 11 which has been produced by joining two yokes 2 of the first embodiment, but which carries the superconducting coil arrangement 3 on the middle or median limb 11.1.

In comparison with a normally conducting winding, the superconducting winding supplies the required high magnetic flux density with a considerably lower energy input, because it is only necessary to apply the electric power for the operation of the cryostat after the production of the current by the superconducting winding. This electric power is only 5% of the electric power which needs to be applied for covering the ohmic losses of a normally conducting winding and for its cooling. This applies not only to melting down but also to a subsequent further heating to a predetermined temperature, e.g. the casting temperature.

While the present invention has been described in detail and with reference to specific embodiments thereof, it will be apparent to one skilled in the art that various changes and modifications can be made therein without departing from the spirit and scope thereof.

The stamp 7 can be made of a non-magnetic non-conducting material such as a ceramic material, for example. It may we advantageous especially in the case of very small metal pieces and especially in the case of metal powders that the stamp is made at least partly of a non-magnetic electrically conducting material. In this case, the stamp will also heat up by the eddy currents and will therefore support the heating of the metal pieces or the powder by direct thermal conduction (and partly also by thermal radiation).

The same considerations also apply to the crucible 1. If it is not made of a ceramic material but of a non-magnetic electrically conducting material, the metal pieces are also indirectly heated by thermal conduction and by thermal radiation especially of the crucible wall in addition to their direct heating by the short-circuit currents, as also the melt accumulating on the floor of the crucible. In certain cases, it may be useful if at least the wall of the crucible consists over at least a part of its height of a non-conducting material. If this is the upper part of the crucible wall for example, it is ensured that the molten material in this upper part will be heated indirectly via the crucible and directly in the bottom part. The upper part ensures the incipient melting and the bottom part ensures the further heat-up.

The crucible can be provided on the inside with a heat-resistant or a refractory lining, as is known from foundry practice for the protection of the vessel walls and for the reduction of losses by thermal radiation. The lining can be lost or permanent.

A rotary drive that is easy to realize can be provided by connecting the floor of the crucible with the end of a drive shaft in a torsion-proof manner. The axis of the drive shaft can coincide with the vertical central axis of the crucible.

The torsion-proof connection between the floor of the crucible and the end of the drive shaft is preferably detachable, e.g. it is arranged as a claw coupling. The crucible can then be removed from the apparatus by means of a conventional hoist and can be transported to the place of use of the metal melt.

The drive shaft can also be arranged horizontally, for example, and can include a pinion gear at its end which meshes with a gear rim on the floor of the crucible. The crucible can alternatively be in engagement on its outside circumference with an apparatus which makes it rotate. The apparatus may include, for example, a gear rim disposed on the wall of the crucible and a driven pinion gear, or of drivers in engagement with a drive chain.

The coil arrangement preferably comprises a ferromagnetic yoke with oppositely disposed, mutually spaced pole pieces, between which the pole faces of the crucible are rotatably held in a contact-free manner. The material of the yoke and its dimensions are appropriately chosen in such a way that the yoke can be operated close to its magnetic saturation. The magnetic leakage losses can be kept at a low level in this way and as a result of the pole pieces. The cross-section of the yoke can be smaller in the region of the winding than in the other areas.

The yoke is preferably substantially C-shaped. The superconducting winding can then be arranged on the middle section of the C-yoke and thus remote from the crucible forming a strong heat source in order to avoid having to apply unnecessarily high cooling power for the cryostat of the winding. In addition, a shield which screens the radiation heat can be applied between the crucible and the cryostat.

With respect to the accessibility of the crucible and its rotational drive it is easiest if the yoke is arranged in a lying fashion in a horizontal plane.

The yoke can principally also be arranged to be upright in a vertical plane, namely such that the middle section of the yoke is disposed beneath the crucible and, if necessary, comprises an opening for the passage of the drive shaft. As in the horizontal arrangement, the crucible can also be removed in this upright arrangement of the yoke upwardly out of the apparatus after the melting down of the metal and can be further transported. In the case of a vertically arranged drive shaft, the coil arrangement can comprise one superconducting winding each on either side of the opening of the yoke for the passage of the drive shaft. For removing the crucible, the stamp can be moved upwardly to a sufficient extent for removing the crucible or/and can be pivoted away laterally.

A further development of the apparatus is that a further yoke with pole pieces is arranged in a rectangular plane containing the yoke, which pole pieces assume a portion of the free space between the pole pieces of the first yoke, and that also at least one coil arrangement with a normally conducting winding however is disposed on a limb of the further yoke and is connected to a current-controllable and preferably also frequency-controllable alternating current source. The normally conducting winding consequently generates a magnetic alternating field which, apart from the un-avoidable leakage flux, also predominantly penetrates the crucible transversely to its central axis, but orthogonally to the direction of the DC magnetic field. Especially in the case of small-size metal pieces, e.g. shredded scrap metal, the magnetic alternating field reduces the initial phase of the heating up to softening or incident melting of the metals. Subsequently, the further coil arrangement and its alternating current source can be switched off.

The apparatus in accordance with the invention can also be expanded for melting down metal pieces and/or metal powders in two separate crucibles. An E-shaped yoke is used instead of a C-shaped yoke. The superconducting coil arrangement is best positioned on it middle limb. The same crucible as in the case of the C-shaped yoke is disposed between the middle limb and the one outside limb of the E-shaped yoke. A further similar crucible with a rotational drive, a lowerable stamp, etc. is disposed between the middle limb and the further outside limb.

As an alternative to a further yoke with an AC-supplied coil arrangement or in addition thereto, the melting-down process can further be accelerated in such a way that a sacrificial plate made of the same metal is added to the crucible together the metal pieces and/or the metal powders.

Although the disclosed inventions are illustrated and described herein as embodied in one or more specific examples, it is nevertheless not intended to be limited to the details shown, since various modifications and structural changes may be made therein without departing from the scope of the inventions and within the scope and range of equivalents of the claims. In addition, various features from one of the embodiments may be incorporated into another of the embodiments. Accordingly, it is appropriate that the appended claims be construed broadly and in a manner consistent with the scope of the disclosure as set forth in the following claims.

It is to be understood that terms such as “left,” “right,” “top,” “bottom,” “front,” “rear,” “side,” “height,” “length,” “width,” “upper,” “lower,” “interior,” “exterior,” “inner,” “outer” and the like as may be used herein, merely describe points or portions of reference and do not limit the present invention to any particular orientation or configuration. Further, terms such as “first,” “second,” “third,” etc., merely identify one of a number of portions, components and/or points of reference as disclosed herein, and do not limit the present invention to any particular configuration or orientation.

What is claimed is:

1. An apparatus for melting down metal pieces and/or metal powders, the apparatus comprising:
a heat-resistant crucible enclosed by at least one coil arrangement generating a DC magnetic field predominantly penetrating the crucible transversely to its central axis and inducing short-circuit currents during rotation of the crucible about its central axis, wherein the coil arrangement comprises at least one superconducting winding in a cryostat; and
a stamp arranged above the crucible, wherein:
the stamp is lowered onto metal pieces contained in the crucible, and
the stamp is rotatably driven in the same direction as the crucible.

2. The apparatus according to claim 1, wherein the stamp comprises driving fingers.

3. The apparatus according to claim 1, wherein the stamp comprises non-magnetic, non-conducting material.

4. The apparatus according to claim 1, wherein the stamp comprises non-magnetic, electrically conducting material.

5. The apparatus according to claim 1, wherein at least the wall of the crucible is formed of non-magnetic, non-conducting material over at least a part of its height.

6. The apparatus according to the claim 1, wherein at least the wall of the crucible is formed of non-magnetic, electrically conducting material over at least a part of its height.

7. The apparatus according to claim 1, wherein the crucible further comprises a heat-resistant or refractory lining.

8. The apparatus according to claim 1, wherein:
the crucible comprises a floor and a side wall surrounding the floor; and
the floor of the crucible is connected in a torsion-proof manner with the end of a drive shaft.

9. The apparatus according to claim 8, wherein the floor of the crucible and the end of the drive shaft are detachable from each other.

10. The apparatus according to claim 1, wherein the apparatus further comprises a rotary device that engages an exterior of the crucible such that the rotary device rotates the crucible about its rotation axis.

11. The apparatus according to claim 1, wherein:
the coil arrangement comprises a ferromagnetic yoke with a first pole piece spaced from a second pole piece, each pole piece defining a pole surface; and
the crucible is arranged between the pole surfaces such that the crucible does not contact the pole surfaces.

12. The apparatus according to claim 11, wherein the yoke is substantially C-shaped, including the first pole piece spaced from the second pole piece by a median section.

13. The apparatus according to claim 12, wherein the superconducting winding is disposed on the median section of the C-shaped yoke.

14. The apparatus according to claim 11, wherein the yoke is oriented to lay within in a horizontal plane.

15. The apparatus according to claim 11, wherein:
the yoke is arranged upright in a vertical plane; and
the middle section of the yoke is disposed beneath the crucible and comprises an opening to permit passage of a drive shaft.

16. The apparatus according to claim 15, wherein:
the ferromagnetic yoke comprises a first ferromagnetic yoke oriented in a horizontal or vertical plane; and
the apparatus further comprises a second ferromagnetic yoke with pole pieces arranged in a plane oriented generally perpendicular to the plane containing the first yoke;
the pole pieces fill a part of the free space between the pole pieces of the first yoke;
the at least one superconducting winding comprises a first superconducting winding;
the apparatus further comprises a second superconducting winding disposed on a limb of the second yoke; and
the second superconducting winding is connected to a current-controllable and frequency-controllable alternating current source.

17. The apparatus according to claim 11, wherein the yoke is substantially E-shaped in order to accommodate a further similar crucible for melting down metal pieces and/or metal powders.

18. A method for melting down metal pieces and/or metal powders comprising, the method comprising:
(a) obtaining an apparatus comprising a heat-resistant crucible enclosed by at least one coil arrangement generating a DC magnetic field predominantly penetrating the crucible transversely to its central axis and inducing short-circuit currents during rotation of the crucible about its central axis, wherein the coil arrangement comprises at least one superconducting winding in a cryostat; and a stamp is arranged above the crucible, wherein the stamp is lowered onto metal pieces contained in the crucible, and the stamp is rotatably driven in the same direction as the crucible;
(b) placing a sacrificial plate in the crucible; and
(c) placing metal pieces and/or metal powders in the crucible,
wherein the sacrificial plate is formed of the same material as the material forming the metal pieces and/or metal powders.
